(19) United States
(12) Patent Application Publication
(10) Pub. No.: US 2007/0087318 A1
(43) Pub. Date: Apr. 19, 2007

(54) Method and Apparatus for Retreiving Large Data and Smaller Data at a Nearly Simultaneous Rate for Subsequent Processing Thereof

(76) Inventors: Hui-Min Chao, Houston, TX (US); David Chao, Houston, TX (US); Nicholas Chao, Houston, TX (US)

Correspondence Address: LAW OFFICES OF LAI & ASSOCIATES, P.C., 5800 RANCHESTER, STE. 200, HOUSTON, TX, 77036, US

(21) Appl. No.: 11/422,148

(22) Filed: Jun. 5, 2006

Related U.S. Application Data
(60) Provisional application No. 60/726,898, filed on Oct. 14, 2005.

(51) Int. Cl. G09B 3/00

(52) U.S. Cl. 434/350

(57) ABSTRACT

The present invention generally relates to a method and apparatus for allowing nearly simultaneous retrieval of large data and small data. In carrying out the method, the first step involves a user interfacing with a first workstation to query a small data storage device for selected data. In the second step, the small data storage device then transmits the selected data to the first workstation while simultaneously communicating with a large data storage device to identify relevant large data files. In the third step, the relevant large file data is transferred from the large data storage device at a transfer rate sufficiently fast enough to reach the first workstation before or about the same time that the smaller data reaches the first workstation, the overall process occurring in a sufficiently short period of time to meet the “on-demand” needs of the user.

### REFERENCE TO RELATED APPLICATIONS

This application claims an invention which was disclosed in Provisional Application No. 60/726,898, filed Oct. 14, 2005, entitled “METHOD AND APPARATUS FOR RETRIEVING LARGE DATA AND SMALLER DATA AT A NEARLY SIMULTANEOUS RATE FOR SUBSEQUENT PROCESSING THEREOF”. The benefit under 35 USC §119(e) of the U.S. provisional application is hereby claimed, and the aforementioned application is hereby incorporated herein by reference.

### BACKGROUND OF THE INVENTION

1. Field of the Invention

The present invention generally relates to data retrieval, and more particularly relates to method and apparatus for retrieving large data and smaller data at a nearly simultaneous rate for subsequent processing thereof.

2. Description of the Related Art

Retrieving data under the control of a set of microprocessors is known. For some type of data such as complicated graphic data, a lot of memory space and retrieving time are required. Furthermore, for these graphic existing data, it is desirable to associate some specific information therewith, and the specific information may be remotely located. As a general matter, this specific information generally requires a smaller memory for data storage.

Therefore, it is desirous to have an improved and efficiently usable method and apparatus for retrieving large data and smaller data at a nearly simultaneous rate for subsequent processing thereof.

### SUMMARY OF THE INVENTION

The present invention generally relates to a method and apparatus for allowing nearly simultaneous retrieval of large data and small data. In carrying out the method, the first step involves a user interfacing with a first workstation to query a small data storage device for selected data. In the second step, the small data storage device then transmits the selected data to the first workstation while simultaneously communicating with a large data storage device to identify relevant large data files. In the third step, the relevant large file data is transferred from the large data storage device at a transfer rate sufficiently fast enough to reach the first workstation before or about the same time that the smaller data reaches the first workstation, the overall process occurring in a sufficiently short period of time to meet the “on-demand” needs of the user. The data could further processed by the workstation, namely combined to form new data, which could then be further used by the user. An example of possible new data would be to create tutorial materials from medical images (the large data) and knowledgebase information from a medical knowledgebase (smaller data).

A method for providing real-time tutorial service in a tutorial system for retrieving, processing, and outputting processed information is provided. The tutorial system includes at least a tutorial module, an image server, and a tutorial service provider. The tutorial module includes at least a main memory, a processor, and a user interface. The method comprises the steps of: select and retrieve data objects from the tutorial service provider and store the data objects in the main memory of the tutorial module. The tutorial service provider then identifies relevant image data objects in the image server. The relevant image data objects from the image server are transferred to the main memory of the tutorial module. The data objects and the relevant image data objects are then processed to generate the tutorial data.

A tutorial system is provided that comprises: a tutorial module, an image server communicationally coupled to the tutorial module, and a tutorial service provider communicationally coupled to the image server; and a method for providing real-time tutorial service in a tutorial system for retrieving, processing, and outputting processed information is provided. The tutorial system includes at least a tutorial module, an image server, and a tutorial service provider. The tutorial module includes at least a main memory, a processor, and a user interface. The method comprises the steps of: select and retrieve data objects from the tutorial service provider and store the data objects in the main memory of the tutorial module. The tutorial service provider then identifies relevant image data objects in the image server. The relevant image data objects from the image server are transferred to the main memory of the tutorial module. The data objects and the relevant image data objects are then processed to generate the tutorial data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a network environment of the present invention.

FIG. 2 is a block diagram of an inside structure of a device of the present invention.

FIG. 3 is a first flowchart of the present invention.

FIG. 4 is a second flowchart of the present invention.

### DETAILED DESCRIPTION OF THE PREFERRED EMBODIMENTS

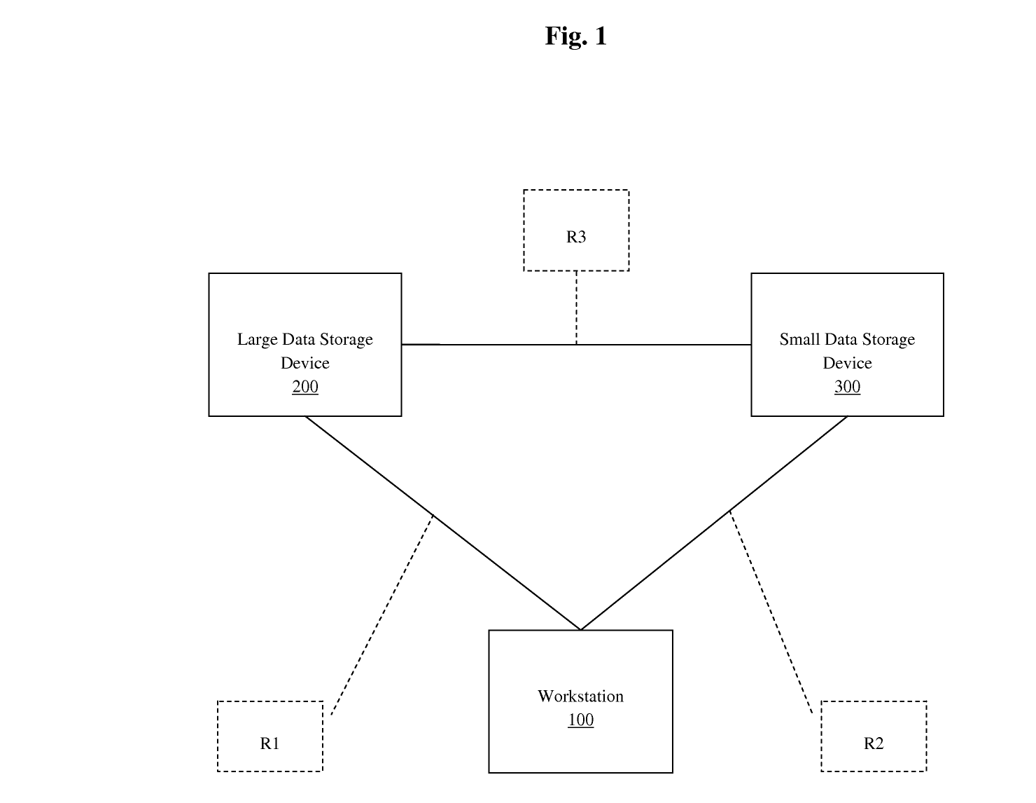

Referring to FIGS. 1-4, embodiments of the present invention are shown. In one embodiment of the invention as shown in FIG. 1, a method is carried out on an apparatus comprising a first workstation 100, a large data storage device 200, a small data storage device 300, and the means of bidirectional communication among the devices and/or work stations at rates R1, R2, and R3 respectively. The first workstation may be a computerized workstation which may include a microprocessor, a display such as a visual monitor, a random access memory (RAM) storage area, a programmable read-only memory storage area such as erasable programmable read-only memory (EPROM) or electrically erasable programmable read-only memory (EEPROM), and an input means such as a command user interface with a keyboard and mouse combination associated therewith. The large data storage device 200 can be located on a second workstation similar to the first workstation. In order to obtain a fast or sufficient rate of transfer required by this invention, the large data storage device 200 may be located on the same local network with the workstation 100 thereby having sufficient bandwidth for communication between workstation 100 and large data storage device 200. The small data storage device 300 may be located on a third workstation similar to the first workstation, and may be located remotely. In other words, the third workstation may be even in a different building or a different city within the same WAN (wide area network) or MAN (metropolitan area network).

In the configuration of FIG. 1, the network connection between the first workstation 100 and the second workstation 200 would be such that it would allow for a data transfer rate that exceeds or is roughly equivalent to the data transfer rate between the first workstation and the third workstation. The network connection between the first workstation 100 and the third workstation 300 can be over a WAN such as the Internet. The network connection between the second workstation 200 and third workstation 300 need only be sufficient enough to quickly transmit the communication identifying from the second workstation 200 to the third workstation 300 sent for the purpose of identifying relevant large data files stored within the second workstation 200. The rate of data transfer rate R1, which is the rate of data transfer between first workstation 100 and second workstation 200 will be similar to rate R2, which is the rate of data transfer between first workstation 100 and third workstation 300 though preferably faster than rate R2. The rate of data transfer rate R3, which is the data transfer rate between second workstation 200 and third workstation 300, would be nearly instantaneous, as the data being transmitted from the small data storage device 300 to the large data storage device 200 is only to identify corresponding data stored on large data storage device 200 that is relevant to the data sought by the user from small data storage device 300.

The data on the large data storage unit 200 may be image files occupying a large storage area, for example, on the order of 10 megabytes or larger. Such files transfer much quicker with a larger bandwidth. For example, a LAN (local-area network) connection with sufficient bandwidth with commonly used error checking scheme transfers data a lot faster or more efficiently than over a WAN connection, such as the Internet.

Once the data from both storage units 200, 300 have been transferred to the workstation 100, a user can perform further processing of the data, such as combining the data to create new data. For example, a user may wish to identify key areas of interest in a large image file depicting a city. The user would query the third workstation 300 from the first workstation 100 for the data identifying key areas of interest for the particular city. The large image file for the city would reside on the second workstation 200 located on the local-area network. The third workstation 300 would send the data containing the key areas of interest to the first workstation 100, while indicating to the second workstation 200 which image file is relevant to the user's request. This large image data file would then be sent, at rate R1 to the first workstation 100 where the image data would be combined with the data containing the key areas of interest. The new combined data can then be displayed on a display such as a visual monitor for further review, and stored as a new file for later retrieval, or outputted in some other form, such as through a printing device.

The geographic image data identified in the above example is exemplary only, and does not serve to limit the embodiment in any way. Other types of images may be used, such as medical images. A user, most likely a medical professional, may wish to identify areas of concern in a topographical scan.

First workstation 100, large data storage device 200, and small data storage device 300 each have an internal structure respectively. For example, a processor, an input-output (I/O) device, a memory of a suitable size, etc. Also, each device has the means of bidirectional communication among the devices at rates R1, R2, and R3 respectively. The means of bidirectional communication may include a wireless transceiver at a desired bandwidth, a network adaptor for coupling to a network such as LAN, MAN, or WAN.

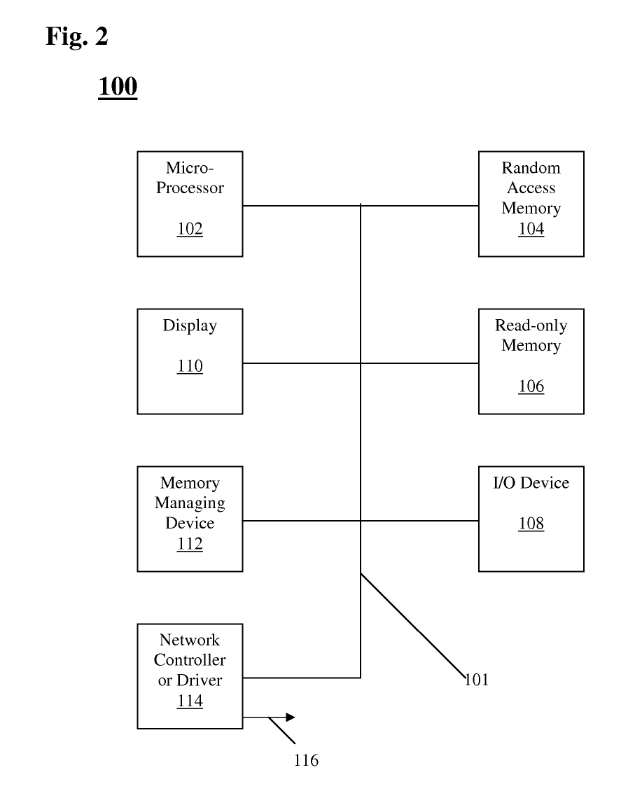

Referring to FIG. 2, an exemplified internal structure of workstation 100 is shown. A bus 101 coupling or connecting the various element of workstation 100 is provided. Bus 101 may carry data as well as instructions. Further, bus 101 may include or be divided into various subsections with each subsection connected with a subset of the various element or units that bus 101 serves as the coupling means. A microprocessor 102 functioning as a central control unit is coupled to bus 101. A random access memory (RAM) is coupled to bus 101 and stores temporary information therein. A read only memory (ROM) is also coupled to bus 101 and stores permanent or semi-permanent information therein. ROM may include erasable programmable read-only memory (EPROM), or Electrically-Erasable Programmable Read-Only Memory (EEPROM), or any ROM known or used. An input-output (I/O) device 108 coupled to bus 101 for interfacing with other outside devices (not shown). A display 110, which may be coupled to I/O device 108, is also coupled with bus 101 for displaying various results or intermediate information of workstation 100. Display 110 may be a cathode ray tube (CRT), a liquid crystal display (LCD), a light emitting diode (LED) display or any suitable display means known or used. A memory managing device 112 for managing memory 104 may be provided and also coupled to bus 101. The functions of memory managing device 112 may be incorporated within microprocessor 102. A network controller or adaptor 114 is coupled to bus 101 as well as a network 116. Network controller 114 may be a Peripheral Component Interconnect (PCI), or a kind of graphic card for interfacing with network 116.

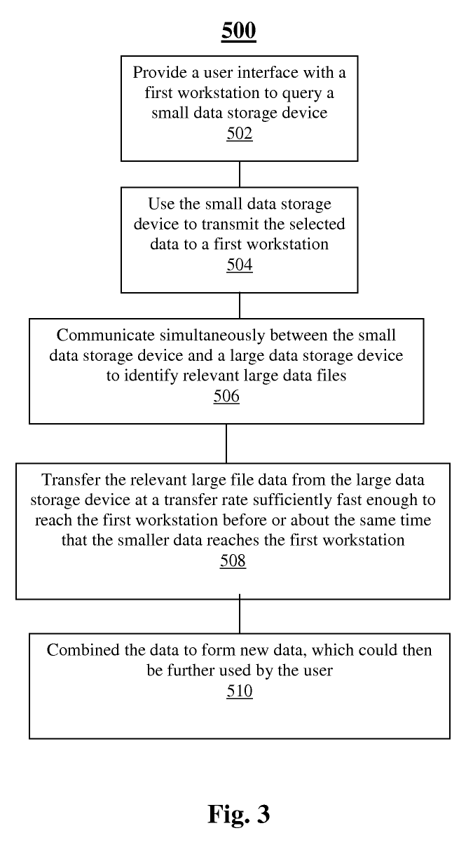

Referring to FIG. 3, a flowchart 500 of the present invention is shown. As can be seen, the invention allows for the nearly simultaneous retrieval of large data and small data for processing by a workstation such as workstation 100 of FIG. 1. In carrying out the method, the first step involves providing a user interface (Step 502) with a first workstation to query a small data storage device for selected data (Step 504). The small data storage device typically has a limited capacity of storing data. In the second step, the small data storage device then transmits the selected data to the first workstation while simultaneously communicating with a large data storage device to identify relevant large data files (Step 506). The large data storage device typically has a large capacity for storing data. In the third step, the relevant large file data is transferred from the large data storage device at a transfer rate sufficiently fast enough to reach the first workstation before or about the same time that the smaller data reaches the first workstation (Step 508). Note that the overall process occurs in a sufficiently short period of time to meet the “on-demand” needs of the user of the present invention. The data could further be processed by the workstation, namely combined to form new data, which could then be further used by the user (Step 510). An example of possible use of the new data would be to create tutorial materials from medical images (the large data) and knowledgebase information from a medical knowledgebase (smaller data).

Another embodiment of the invention is computer-readable media containing computer-readable instructions which when executed, implement the method described. Such computer readable media can be embodied within the workstations described in the apparatus.

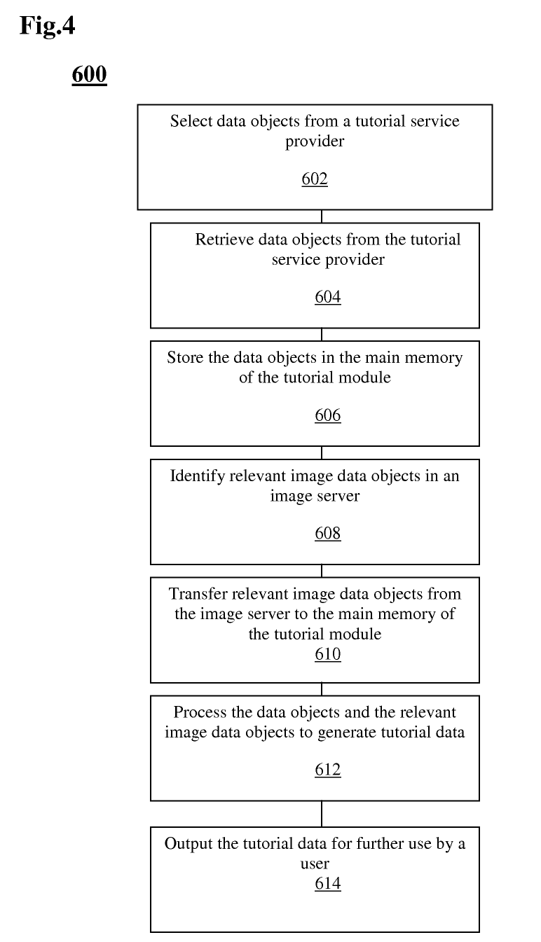

Referring to FIG. 4, a flow chart 600 depicts a method for providing real-time tutorial service in a tutorial system for retrieving, processing, and outputting the processed information. The tutorial system includes at least a tutorial module, a DICOM (Digital Imaging and Communications in Medicine) image server, and a tutorial service provider. The tutorial module includes at least a main memory, a processor, and a user interface. The method includes the steps of: select (Step 602) and retrieve (Step 604) data objects from the tutorial service provider and store (Step 606) the data objects in the main memory of the tutorial module. The tutorial service provider then identifies (Step 608) relevant image data objects in the DICOM image server. The relevant image data objects from the DICOM image server is transferred to the main memory of the tutorial module (Step 610). The data objects and the relevant image data objects are in turn processed (Step 612) to generate tutorial data. The tutorial data may be outputted (Step 614) for further use by the user.

One embodiment of the invention is implemented as a program product for use with a computer system such as, for example, the network environment 100 shown in FIG. 1 or the internal structure of a device depicted in FIG. 2 and described below. The program(s) of the program product defines functions of the embodiments (including the methods described below with reference to FIGS. 3 and 4 and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications, as well as flash memory and its associated memory devices. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to embodiments of the present invention, other and further embodiments of the invention may be devised without departing from the basic scope thereof, and the scope thereof is determined by the claims that follow.

What is claimed is:

1. A method for providing real-time tutorial service in a tutorial system for retrieving, processing, and outputting processed information, said tutorial system including at least a tutorial module, an image server, and a tutorial service provider, said tutorial module including at least a main memory, a processor, and a user interface, said method comprising the steps of:
selecting and retrieving data objects from said tutorial service provider and storing said data objects in said main memory of said tutorial module;
said tutorial service provider, identifying relevant image data objects in said image server;
transferring said relevant image data objects from said image server to said main memory of said tutorial module; and
processing said data objects and said relevant image data objects to generate tutorial data.

2. The method of claim 1 further comprising outputting said tutorial data for further use by a user.

3. The method of claim 1, wherein the image server is a Digital Imaging and Communications in Medicine (DICOM) server.

4. The method of claim 1, wherein said outputting step comprises displaying said tutorial data on a display.

5. The method of claim 1, wherein said transferring step comprises transferring at about the same rate of transfer as retrieving data objects from said tutorial service provider.

6. A tutorial system comprising:
a tutorial module,
an image server communicationally coupled to said tutorial module, and
a tutorial service provider communicationally coupled to said image server; and a method for providing real-time tutorial service for retrieving, processing, and outputting processed information, said tutorial system including, said method comprising the steps of:
selecting and retrieving data objects from said tutorial service provider and storing said data objects in said main memory of said tutorial module;
said tutorial service provider, identifying relevant image data objects in said image server;
transferring said relevant image data objects from said image server to said main memory of said tutorial module; and
processing said data objects and said relevant image data objects to generate tutorial data.

7. The system of claim 6, wherein said tutorial module comprises at least one main memory.

8. The system of claim 6, wherein said tutorial module comprises at least one processor for co-coordinating communicates between a set of different devices.

9. The system of claim 6, wherein said tutorial module comprises at least one user interface.

10. The system of claim 6, wherein said method further comprises outputting said tutorial data for further use by a user.

11. The system of claim 6, wherein the image server is a Digital Imaging and Communications in Medicine (DICOM) server.

12. The system of claim 6, wherein said outputting step comprises displaying said tutorial data on a display.

13. The system of claim 6, wherein said transferring step comprises transferring at about the same rate of transfer as retrieving data objects from said tutorial service provider.
